(19) United States
(12) Patent Application Publication
(10) Pub. No.: US 2025/0198509 A1
(43) Pub. Date: Jun. 19, 2025

(54) METHODS AND SYSTEMS FOR A TWO SPEED POWERSHIFTING TRANSMISSION

(71) Applicant: Dana Belgium N.V., Brugge (BE)

(72) Inventors: Joachim VAN DINGENEN, Drongen (BE); Bert HANNON, Brugge (BE)

(21) Appl. No.: 18/540,376

(22) Filed: Dec. 14, 2023

(51) Int. Cl. F16H 61/04; B60K 1/02; F16H 3/08; F16H 3/093; F16H 61/684

(52) U.S. Cl. CPC F16H 61/04; B60K 1/02; F16H 3/093; F16H 61/684; F16H 2003/0811; F16H 2003/0818; F16H 2003/0931; F16H 2061/0433; F16H 2061/0474; F16H 2200/0021; F16H 2200/0034

(57) ABSTRACT

Systems and methods for an electric drive unit are provided. In one example, an electric drive unit comprises a transmission system comprising a plurality of motor-transmission subassemblies each comprising an electric motor coupled to an input shaft comprising a first and second gear, and a intermediate shaft comprising a dog clutch selector, a first and second clutch gear, wherein the first clutch gear meshes with the first gear of the input shaft and the second clutch gear meshes with the second gear of the input shaft and wherein the dog clutch selector is configured to selectively couple the first or second clutch gear to the intermediate shaft; and an output shaft rotationally coupled to the plurality of motor-transmission subassemblies; and a controller configured to, in response to a powershift request, increase torque of at least one electric motor while at least one other motor-transmission subassembly is shifting.

### TECHNICAL FIELD

The present disclosure relates generally to transmissions, more specifically to two speed transmissions for electric vehicles.

### BACKGROUND AND SUMMARY

Electric vehicles and partially electric hybrid vehicles make use of electric drive units to generate motive power and provide an attractive alternative in terms of hydrocarbon emissions in relation to vehicles that solely rely on internal combustion engines for propulsion. Efficiency of the drive unit affects not only the footprint of the vehicle but also range of the vehicle for a given battery and/or fuel tank capacity.

Off-highway vehicles, such as mining vehicles, material handling vehicles, construction and/or forestry vehicles, as well as all-terrain vehicles (ATVs), recreational off-highway vehicles (ROVs), and utility task vehicles (UTVs), among others, are configured for driving on unpaved surfaces, such as trails and dirt roads that have low traction surfaces. As such, off-highway vehicles may demand a combination of high tractive effort at low speeds and a relatively high top speed, which may lend itself to low power and/or high power demands depending on application. Off-highway vehicles may demand higher and/or lower power as on-highway applications. Compensation may be made for high power systems by adding additional motors.

Multi-speed transmissions of the countershaft shaft type may include one or more clutches and associated gears operatively assembled on a plurality of shafts, including an input shaft, an intermediate shaft, and an output shaft. Power input to the input shaft is provided by a prime mover, such as an electric motor, and is transmitted towards the output shaft by one of the one or more clutches.

The inventors have recognized various issues with such an approach. For example, in order for the prime mover of such a system to output demanded performance for an off-highway system, a high power electric motor may be selected. High power electric motors may be higher cost per kW due to availability and lower yearly production volumes than low power motors.

The inventors herein have recognized these issues and developed a two-speed transmission system that at least partially addresses these issues. In one embodiment, the approaches disclosed herein provide an electric transmission system comprising a plurality of motor-transmission subassemblies. For example, the transmission system comprises three electric motors, each coupled to respective inverters. Each of the motor-transmission subassemblies comprises an input shaft driven by the electric motor and an intermediate shaft. Each input shaft includes a first gear and a second gear, wherein the first gear is selectively couplable to the intermediate shaft via a first clutch gear of a dog clutch selector and the second gear is selectively couplable to the intermediate shaft via a second clutch gear of the dog clutch selector. Engagement of the first clutch gear of the dog clutch selector may be a first gear and engagement of the second clutch gear of the dog clutch selector may be a second gear. The three-motor system of the transmission allows for high power without demanding individual high power motors.

Each of the motor-transmission subassemblies may be coupled to an output system. In one examples, the output system comprises an output shaft and an output shaft gear. The output shaft may be coupled to each of the intermediate shafts via the output shaft gear, wherein each of the intermediate shafts includes an intermediate shaft gear that meshes with the output shaft gear. In another example, each of the intermediate shafts may couple to a layshaft via a meshing between a layshaft gear and each of the intermediate shaft gears. The layshaft may then be coupled to an output shaft via the layshaft gear. In this way, various output systems may be included in the transmission based application needs, including position of output interfaces within a transmission housing, as an example.

A powershifting strategy between the first and second gear is herein provided. The transmission system may be controlled via a controller that, in response to a powershift request, sequentially shifts each motor-transmission subassembly from one gear to another. The powershifting strategy may include reducing torque of a first electric motor of a first motor-transmission subassembly to zero while increasing torque of the other two electric motors to 150% of their pre-shift torques in order to maintain a substantially constant output torque. The first motor-transmission subassembly is then shifted into neutral and a speed of the first electric motor is decreased to synchronize with second gear speed. With the speed of the first electric motor increased, the first motor-transmission subassembly is shifted into second gear. In one example, this process is repeated for a second motor-transmission subassembly and a third motor-transmission subassembly to shift the transmission system fully into second gear. In some examples, one or two of the motor-transmission subassemblies may remain in the first gear ratio when an output speed range in the first gear ratio overlaps with an output speed range in the second gear ratio.

The power shift strategy herein allows the transmission system to efficiently shift between gears while maintaining a continuous output torque, providing for a smooth shifting experience for the driver. Dog clutches as included in the transmission system may increase efficiency of the system as there is no energy lost by friction, which occurs for synchronizer clutches or wet clutches.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows a schematic of an exemplary vehicle.

FIG. 2 shows a schematic of a two-speed transmission system according to a first embodiment.

FIG. 3A shows a power path in the transmission in a first operating gear ratio of the two-speed transmission system.

FIG. 3B shows a power path in the transmission in a second operating gear ratio of the two-speed transmission system.

FIG. 4 shows a schematic of a two-speed transmission system according to a second embodiment.

FIG. 5 shows a schematic of a two-speed transmission system according to a third embodiment.

FIG. 6 shows a table indicating configurations of clutches in operating gears of the transmission.

FIG. 7 is a timing diagram for a use-case transmission control strategy.

FIG. 8 is a flowchart depicting a method of operation for a two-speed transmission in an electric vehicle according to an embodiment.

### DETAILED DESCRIPTION

The following description relates to systems and methods for a two-speed powershift transmission for an electric vehicle comprising three electric motors. The transmission system includes a plurality of shafts and gears, including an input shaft and an intermediate shaft for each of a plurality of motor-transmission subassemblies. Each of the plurality of motor-transmission subassemblies includes a clutch selector that selects between a first gear, a second gear, and neutral based on operating conditions. Each of the plurality of motor-transmission subassemblies is coupled to an output system that includes at least an output shaft with an output shaft gear.

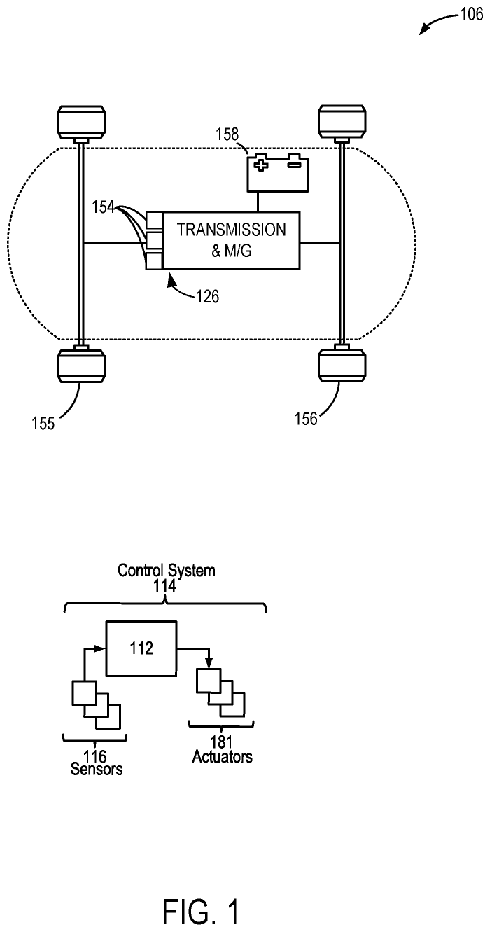

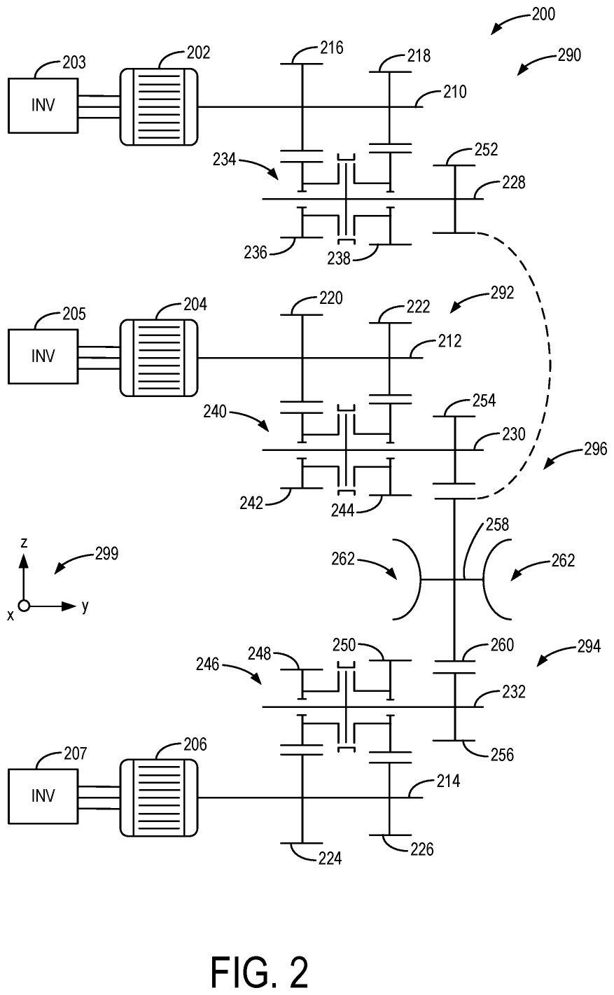

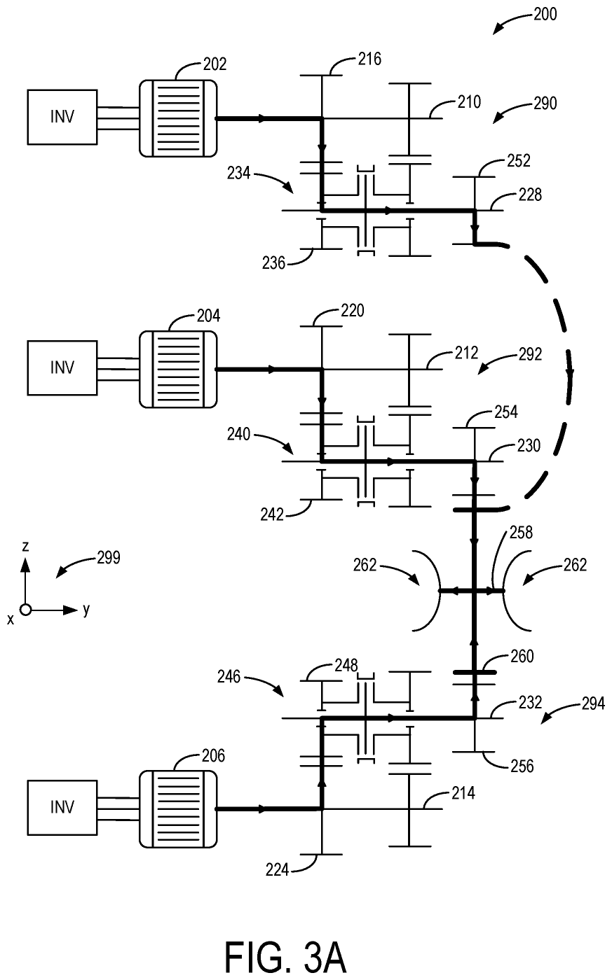

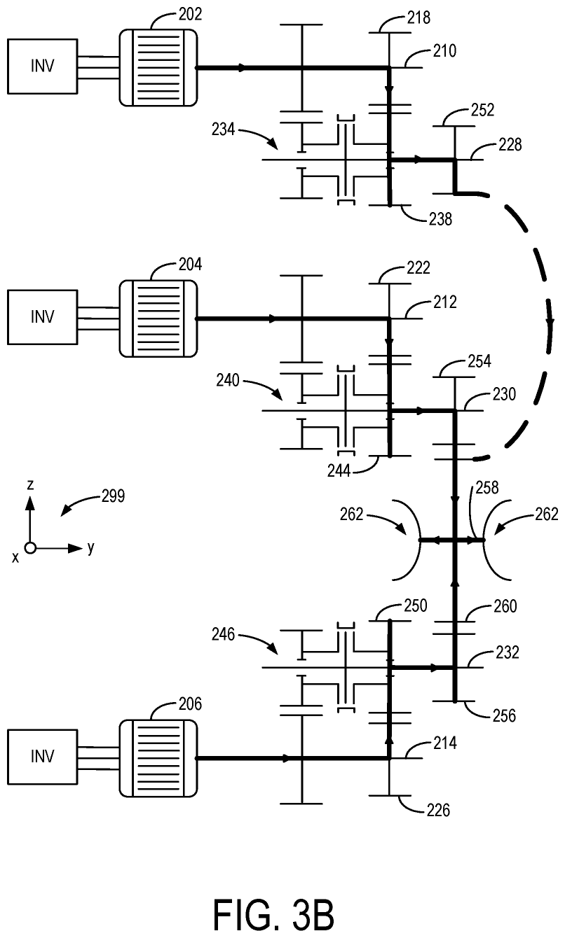

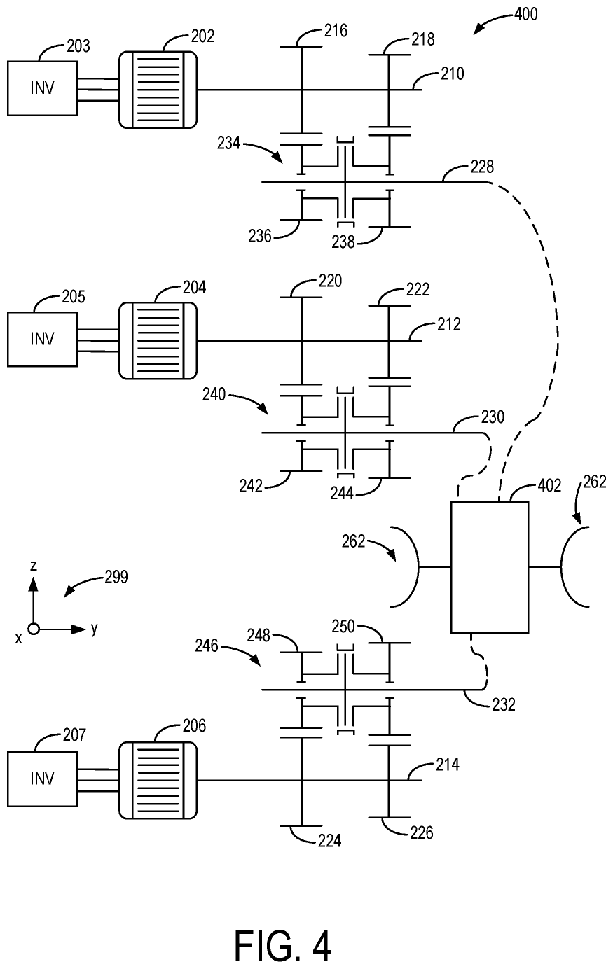

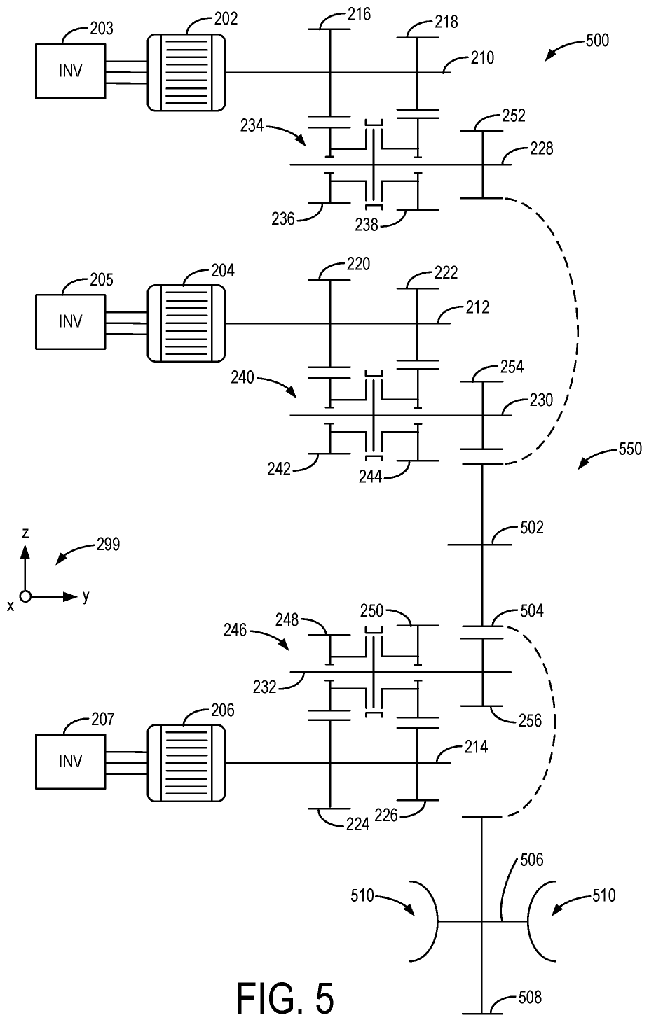

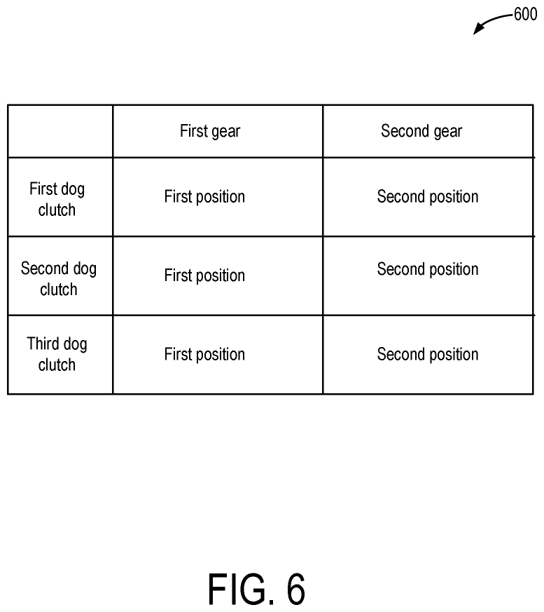

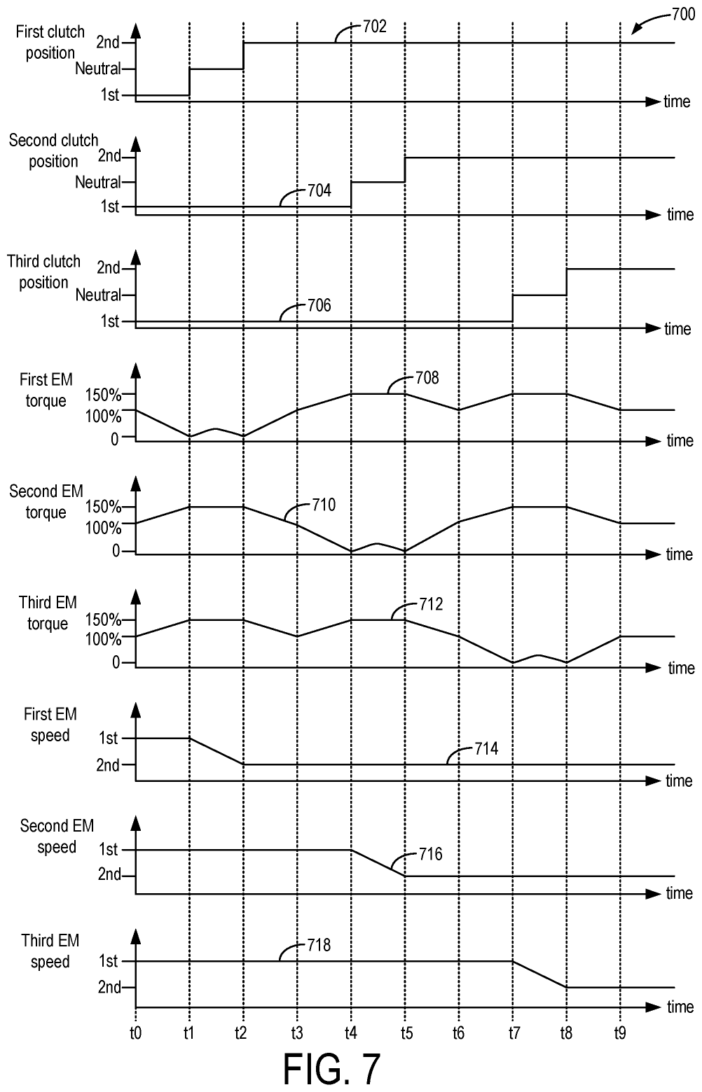

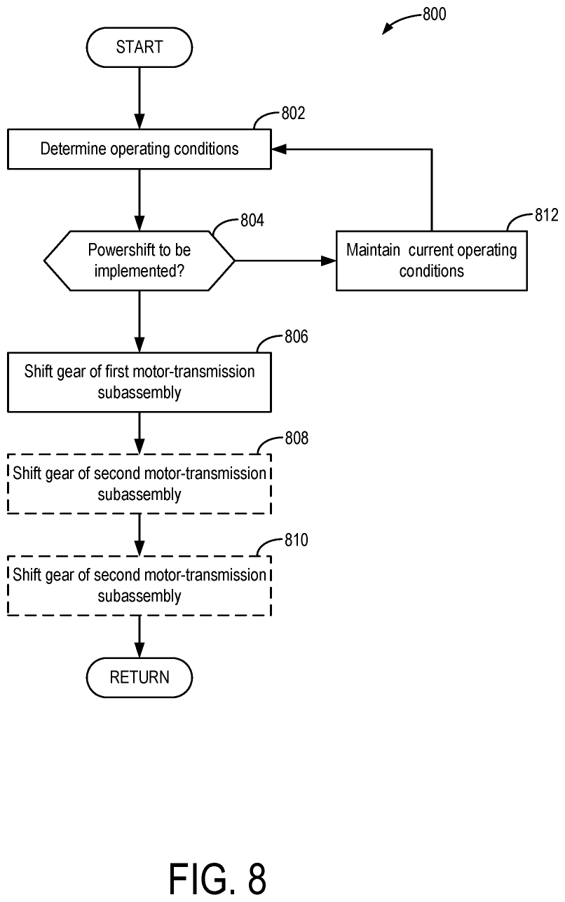

An exemplary electric vehicle is shown in FIG. 1. A first embodiment of the layout of the transmission system is depicted in a diagram in FIG. 2. Power paths through the transmission system of FIG. 2 for a first gear ratio and a second gear ratio are shown in FIGS. 3A and 3B, respectively. A second embodiment of the layout of the transmission system is depicted in a diagram in FIG. 4. A third embodiment of the layout of the transmission system is depicted in a diagram in FIG. 5. Clutch positions for a first and second gear of the transmission system are shown in a table in FIG. 6. A timing diagram of a use-case scenario for powershifting the transmission system is shown in FIG. 7. A method of operation of the transmission system is shown in a flowchart in FIG. 8.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 1 is a schematic drawing that depicts an electric vehicle 106 with an electric drive unit that generates motive power for vehicle propulsion. The electric vehicle 106 may be a light, medium, or heavy duty vehicle. Specifically, in one use-case example, the electric vehicle 106 may be an off-highway vehicle. However, in other examples, the electric vehicle 106 may be a passenger vehicle such as a truck, sedan, wagon, and the like. Further, the electric vehicle 106 may be a battery electric vehicle (BEV), a series hybrid electric vehicle (HEV) that includes an internal combustion engine, or a fuel-cell electric vehicle, as non-limiting examples.

In one embodiment, the electric vehicle 106 may include an electric drive unit 126. The electric drive unit 126 comprises one or more electric motors 154. Electric motors 154 may be traction motors. Electric motors 154 may receive electrical power from a traction battery 158 to provide torque to rear vehicle wheels 155. Electric motors 154 may also be operated as a generator to provide electrical power to charge traction battery 158, for example during a braking operation. It should be appreciated that while FIG. 1 depicts three electric motors, other configurations are possible that include more or less electric motors. Additionally, it should be appreciated that while FIG. 1 depicts transmission 126 with electric motors 154 mounted in a central drive configuration with drive shafts towards the front and rear axles, other configurations are possible, such as employing electric motors 154 in an axle configuration (front or rear), or in a configuration in which there is one or more electric motors mounted to both the rear vehicle wheels 155 and front vehicle wheels 156.

Electric motors 154 may be coupled to an outside of a transmission/gearbox housing. The transmission/gearbox housing may house a transmission system. The transmission system may include a plurality of motor-transmission subassemblies each comprising a plurality of shafts and gears and a clutch selector. A controller 112 may send a signal to actuator(s) of the clutch selectors to shift respective positions of the clutch selectors, so as to shift gears for power transmission from the electric motors 154 to the rear vehicle wheels 155 and/or the front vehicle wheels 156. In one example, the electric vehicle 106 includes a two-speed schematic wherein powershifting is possible.

Controller 112 may form a portion of a control system 114. Controller 112 may include a microcomputer with components such as a processor (e.g., a microprocessor unit), input/output ports, an electronic storage medium for executable programs and calibration values (e.g., a read-only memory chip, random access memory, keep alive memory, a data bus, and the like). The storage medium may be programmed with computer readable data representing instructions executable by a processor for performing the methods and control techniques described herein as well as other variants that are anticipated but not specifically listed. Control system 114 is shown receiving information from a plurality of sensors 116 and sending control signals to a plurality of actuators 181. For example, the sensors 116 may include a pedal position sensor designed to detect a depression of an operator-actuated pedal such as an accelerator pedal and/or brake pedal, a speed sensor at the transmission output shaft, energy storage device state of charge (SOC) sensor, clutch position sensors, and the like. Motor speed may be ascertained from the amount of power sent from an inverter to an electric machine. An input device (e.g., accelerator pedal, brake pedal, drive mode selector, combinations thereof, and the like) may further provide input signals indicative of an operator's intent for vehicle control. As another example, the actuators may include the clutch, etc.

Upon receiving the signals from the various sensors 116 of FIG. 1, the controller 112 processes the received signals and employs various actuators 181 of vehicle components to adjust the components based on the received signals and instructions stored in the memory of controller 112. For example, the controller 112 may receive an accelerator pedal signal indicative of an operator's request for increased vehicle acceleration. In response, the controller 112 may command operation of inverters to adjust electric machine power output and increase power delivered from the electric machine(s) to the transmission. The controller 112 may, during certain operating conditions, be designed to send commands to clutches to engage and disengage clutch gears. For instance, a control command may sent to a clutch and in response to receiving the command, an actuator in the clutch may adjust the clutch based on the command for clutch engagement or disengagement. The other controllable components in the vehicle may function in a similar manner with regard to sensor signals, control commands, and actuator adjustment, for example.

Referring now to FIG. 2, a diagram of a transmission system 200 according to a first embodiment is shown. The transmission system 200 includes a plurality of motor-transmission subassemblies, including a first motor-transmission subassembly 290, a second motor-transmission subassembly 292, and a third motor-transmission subassembly 294. The first motor-transmission subassembly 290 may comprise a first electric motor 202 coupled to a first inverter 203, the second motor-transmission subassembly 292 may comprise a second electric motor 204 coupled to a second inverter 205, and the third motor-transmission subassembly 294 may comprise a third electric motor 206 coupled to a third inverter 207. The first, second, and third electric motors may be configured to provide a desired amount of tractive power for off-highway operations as well as a target top speed and speed on ramp. The use of multiple motors in the electric drive unit therefore enables the unit to attain end-use performance goals.

Each of the first, second, and third electric motors may include conventional components such as rotors and stators that electromagnetically interact during operation to generate motive power. Further, in one example, the electric motors may be motor-generators which are designed to generate electrical energy during regenerative operation. Still further, the electric motors may have similar designs and sizes, in some instances. In this way, manufacturing efficiency may be increased. However, the electric motors may have differing sizes and/or designs, in alternate examples.

The first, second, and third electric motors 202, 204, and 206 may be electrically coupled to one or more energy storage devices (e.g., one or more traction batteries, capacitor(s), fuel cells, combinations thereof, and the like) by way of the first, second, and third inverters 203, 205, and 207, respectively. These inverters and other inverters described herein are designed to convert direct current (DC) to alternating current (AC) and vice versa. In one use-case example, the first, second, and third electric motors 202, 204, and 206 and the respective first, second, and third inverters 203, 205, and 207 may be three-phase devices. However, motors and inverters designed to operate using more than three phases have been envisioned.

Each of the plurality of motor-transmission subassemblies may comprise an input shaft coupled to its respective motor. For example, the first electric motor 202 may be coupled to a first input shaft 210, the second electric motor 204 may be coupled to a second input shaft 212, and the third electric motor 206 may be coupled to a third input shaft 214. Each of the input shafts may be rotationally coupled to a first and a second gear. For example, the first input shaft 210 may be rotationally coupled to a first gear 216 and a second gear 218 of the first motor-transmission subassembly 290, the second input shaft 212 may be rotationally coupled to a first gear 220 and a second gear 222 of the second motor-transmission subassembly 292, and the third input shaft 214 may be rotationally coupled to a first gear 224 and a second gear 226 of the third motor-transmission subassembly 294.

Further, each of the plurality of motor-transmission subassemblies may comprise an intermediate shaft coupled to the respective input shafts via gear meshes. For example, the first motor-transmission subassembly 290 may comprise a first intermediate shaft 228, the second motor-transmission subassembly 292 may comprise a second intermediate shaft 230, and the third motor-transmission subassembly 294 may comprise a third intermediate shaft 232. Each of the intermediate shafts may comprise a first and a second clutch gear that are selectively couplable to the intermediate shaft via a dog clutch selector. The first gear 216 of the first motor-transmission subassembly 290 may mesh with a first clutch gear 236 that is selectively rotationally couplable to the first intermediate shaft 228 via first dog clutch selector 234. The second gear 218 of the first motor-transmission subassembly 290 may mesh with a second clutch gear 238 that is selectively rotationally couplable to the first intermediate shaft 228 via first dog clutch selector 234.

Similarly, the first gear 220 of the second motor-transmission subassembly 292 may mesh with a first clutch gear 242 that is selectively rotationally couplable to the second intermediate shaft 230 via second dog clutch selector 240. The second gear 222 of the second motor-transmission subassembly 292 may mesh with a second clutch gear 244 that is selectively rotationally couplable to the second intermediate shaft 230 via second dog clutch selector 240. The first gear 224 of the third motor-transmission subassembly 294 may mesh with a first clutch gear 248 that is selectively rotationally couplable to the third intermediate shaft 232 via third dog clutch selector 246. The second gear 226 of the third motor-transmission subassembly 294 may mesh with a second clutch gear 250 that is selectively rotationally couplable to the third intermediate shaft 232 via third dog clutch selector 246.

Each of the first, second, and third dog clutch selectors 234, 240, and 246 may have a first position, a second position, and a neutral position. In the first position, the first clutch gear of the respective dog clutch selector may be engaged and the second clutch gear of the respective dog clutch selector may be disengaged. In the second position, the second clutch gear of the respective dog clutch selector may be engaged and the first clutch gear of the respective dog clutch selector may be disengaged. In the neutral position, both the first and second clutch gears of the respective dog clutch selector may be disengaged. As an example, for the first motor-transmission subassembly 290, the first dog clutch selector 234 may have a first position in which the first clutch gear 236 is engaged with the first intermediate shaft 228 and the second clutch gear 238 is disengaged from the first intermediate shaft 228, a second position in which the second clutch gear 238 is engaged with the first intermediate shaft 228 and the first clutch gear 236 is disengaged from the first intermediate shaft 228, and a neutral position in which both the first clutch gear 236 and second clutch gear 238 are disengaged from the first intermediate shaft 228. The second and third motor-transmission subassemblies 292, 294 have first, second, and neutral positions in a similar fashion.

In some examples, when each of the first, second, and third motor-transmission subassemblies have respective dog clutch selectors in the first position, the transmission system 200 may be in a first gear ratio and when each of the first, second, and third motor-transmission subassemblies have respective dog clutch selectors in the second position, the transmission system 200 may be in a second gear ratio. When one or more of the dog clutch selectors are in neutral, the transmission system 200 may be in a transfer state, for example during a powershift, as will be described further with respect to FIG. 7. Further, when one or more of the subassemblies are in the first gear ratio and one or more others of the subassemblies are in the second gear ratio, the transmission system 200 may be in an overlapping gear ratio, as will be further described below.

Dog clutches, as herein included in the transmission system 200, may increase efficiency of the system. Dog clutches, because they connect (e.g., engage the clutch gears as herein described) without friction allow for shafts (e.g., the input shafts and the intermediate shafts of respective motor-transmission subassemblies) to rotate at the same speed without slipping. Because dog clutches do not operate with friction, heat generation may be avoided, therefore reducing degradation to the oil Further, while dog clutches with three positions are herein described, dog clutches with only two positions to engage/disengage a single gear mesh may also be used, in other examples. While dog clutches are herein described throughout, other clutch types, such as synchronizers, friction clutches, dual-clutches, dry clutches, or other type of clutches, may be used instead of dog clutches.

In some examples, as is shown in the first embodiment in FIG. 2, each of the intermediate shafts may be rotationally coupled to a gear of an output system 296. For example, the first intermediate shaft 228 may be rotationally coupled to gear 252, second intermediate shaft 230 may be rotationally coupled to gear 254, and third intermediate shaft 232 may be rotationally coupled to gear 256. Each of the gears 252, 254, and 256 may couple respective intermediate shafts to an output shaft 258 of the output system 296 via an output shaft gear 260. For example, the gear 252 rotationally coupled to the first intermediate shaft 228 may mesh with the output shaft gear 260, the gear 254 rotationally coupled to the second intermediate shaft 230 may mesh with the output shaft gear 260, and the gear 256 rotationally coupled to the third intermediate shaft 232 may mesh with the output shaft gear 260.

The output shaft 258 may couple to one or more output interfaces 262. The one or more output interfaces 262 may be designed to attach to axles (not shown) via shafts, couplings, changes, combinations thereof, and the like. Such axles may include components such as differentials, axle shafts, and drive wheels (e.g., front vehicle wheels 156 and rear vehicle wheels 155 of FIG. 1). The output shaft 258 may be configured to transfer rotational torque to the axles. In some examples, a first output interface may lead to a front axle and a second output interface may lead to a rear axle. The one or more output interfaces 262 may be flanges, yokes, splines, joints, combinations thereof, or the like. In this way, each of the first, second, and third motors 202, 204, and 206 may transfer power and torque to the one or more output interfaces 262 via respective motor-transmission subassemblies to allow for a greater combined output torque than with, for example, a single motor. Further, lower power single motors may be used to result in the same output torque as one or two higher power motors. Lower power motors may be more accessible and efficient to manufacture, therefore increasing manufacturing efficiency of the transmission system herein described.

An axis system 299 is provided in FIGS. 2-5 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Each of the shafts included in the transmission system 200 may be oriented along the longitudinal axis and may be parallel to each other. In some examples, the first, second, and third motor-transmission subassemblies 290, 292, and 204 may be parallel to each other along the longitudinal axis and in the same vertical axis so as to be positioned in contact with the output system 296.

Power paths through the transmission system 200 according to the first embodiment are shown in FIGS. 3A and 3B. FIG. 3A specifically shows a power path through the transmission system 200 when fully in the first gear ratio and FIG. 3B specifically shows a power path through the transmission system 200 when fully in the second gear ratio. Directionality of mechanical power transfer through the transmission system 200 may be altered by actual speed (direction) of the wheels and actual torque (direction) of the motors. The transmission system 200 may allow for each of the respective dog clutch selectors to be engaged in one of three positions depending on selected gear ratio and/or transfer state.

In the power path of the first gear ratio as depicted in FIG. 3A, power of the first electric motor 202 is transferred into the first input shaft 210. From the first input shaft 210, power is transferred into the first intermediate shaft 228 via the first gear 216 meshed with the first clutch gear 236 when the first dog clutch selector 234 is in the first position and the first clutch gear 236 is engaged with the first intermediate shaft 228. Power of the first electric motor 202 is then transferred to the output shaft 258 via meshing of the gear 252 of the first intermediate shaft 228 and the output shaft gear 260.

Power of the second electric motor 204 is transferred into the second input shaft 212. From the second input shaft 212, power is transferred into the second intermediate shaft 230 via the first gear 220 meshed with the first clutch gear 242 when the second dog clutch selector 240 is in the first position and the first clutch gear 242 is engaged with the second intermediate shaft 230. Power of the second electric motor 204 is then transferred to the output shaft 258 via meshing of the gear 254 of the second intermediate shaft 230 and the output shaft gear 260.

Power of the third electric motor 206 is transferred into the third input shaft 214. From the third input shaft 214, power is transferred into the third intermediate shaft 232 via the first gear 224 meshed with the first clutch gear 248 when the third dog clutch selector 246 is in the first position and the first clutch gear 248 is engaged with the third intermediate shaft 232. Power of the third electric motor 206 is then transferred to the output shaft 258 via meshing of the gear 256 of the third intermediate shaft 232 and the output shaft gear 260. In this way, power of the first, second, and third electric motors 202, 204, and 206 may be combined to produce an output torque demanded by a vehicle (e.g., electric vehicle 106).

In the power path of the second gear ratio as depicted in FIG. 3B, power of the first electric motor 202 is transferred into the first input shaft 210. From the first input shaft 210, power is transferred into the first intermediate shaft 228 via the second gear 218 meshed with the second clutch gear 238 when the first dog clutch selector 234 is in the second position and the second clutch gear 238 is engaged with the first intermediate shaft 228. Power of the first electric motor 202 is then transferred to the output shaft 258 via meshing of the gear 252 of the first intermediate shaft 228 and the output shaft gear 260.

Power of the second electric motor 204 is transferred into the second input shaft 212. From the second input shaft 212, power is transferred into the second intermediate shaft 230 via the second gear 222 meshed with the first clutch gear 242 when the second dog clutch selector 240 is in the first position and the first clutch gear 242 is engaged with the second intermediate shaft 230. Power of the second electric motor 204 is then transferred to the output shaft 258 via meshing of the gear 254 of the second intermediate shaft 230 and the output shaft gear 260.

Power of the third electric motor 206 is transferred into the third input shaft 214. From the third input shaft 214, power is transferred into the third intermediate shaft 232 via the first gear 224 meshed with the first clutch gear 248 when the third dog clutch selector 246 is in the first position and the first clutch gear 248 is engaged with the third intermediate shaft 232. Power of the third electric motor 206 is then transferred to the output shaft 258 via meshing of the gear 256 of the third intermediate shaft 232 and the output shaft gear 260. In this way, power of the first, second, and third electric motors 202, 204, and 206 may be combined to produce an output torque demanded by a vehicle (e.g., electric vehicle 106).

The output system of a transmission system according to the present disclosure may have varying layouts. While an output shaft coupled to each of the intermediate shafts via an output shaft gear meshing with a gear of each of the intermediate shafts is presented in the first embodiment described with respect to FIGS. 2-3B, other embodiments are possible. FIG. 4 shows an embodiment of a transmission system 400 that includes the same plurality of motor-transmission subassemblies as the transmission system 200, and therefore similar component numbering is used. However, an output system 402 of the transmission system 400 may have a different layout.

As an example, the first, second, and third intermediate shafts 228, 230, and 232 may rotationally couple to the output system 402, wherein the output system 402 comprises one or more shafts and one or more gears to transfer power from the first, second, and third electric motors 202, 204, and 206 to the one or more output interfaces 262.

In some examples, in the transmission system 400, one or more of the first, second, and third dog clutch selectors 234, 240, and 246 may be replaced by fixed gear sets. In such examples, one or more of the electric motors that correspond to the one or more fixed gear sets may continuously drive in a selected gear, e.g., first or second gear. As such, the transmission system may drive fully in the selected gear ratio or in an overlapping gear ratio.

FIG. 5 presents a second embodiment of a transmission system 500 with a different output system layout than the transmission system 200. The transmission system 500 may comprise the same plurality of motor-transmission subassemblies as the transmission system 200 and therefore similar component numbering is used.

The transmission system 500 may comprise an output system 550. The output system 550 may comprise a plurality of gears rotationally coupled to the plurality of intermediate shafts, similar to as described with respect to the transmission system 200. For example, gear 252 may rotationally couple to the first intermediate shaft 228, gear 254 may rationally couple to the second intermediate shaft 230, and gear 256 may rotationally couple to the third intermediate shaft 232. Each of the third gears 252, 254, and 256 may rotationally couple to a layshaft 502 via first gear meshings with a layshaft gear 504. The layshaft may further rotationally couple to an output shaft 506 via a second gear meshing of the layshaft gear 504 and an output shaft gear 508. Similar to as described with respect to FIG. 2, the output shaft 506 may couple to one or more output interfaces 510. The one or more output interfaces 510 may be designed to attach to axles (not shown) via shafts, couplings, changes, combinations thereof, and the like. Such axles may include components such as differentials, axle shafts, and drive wheels (e.g., front vehicle wheels 156 and rear vehicle wheels 155 of FIG. 1). In this way, the output shaft 506 may be configured to transfer rotational torque to the axles.

The output system 550 of the transmission system 500 and the output system 296 of transmission system 200 may be two examples of layouts of the output system 402 of transmission system 400, though it should be understood that various other output system layouts are possible without departing from the scope of this disclosure. For example, an output system may comprise a first layshaft rotationally coupled to the first and second intermediate shaft and rotationally coupled to a second layshaft and/or an output shaft while the third intermediate shaft is rotationally coupled directly to the output shaft. Other various layouts have been imagined. The various possible layouts for the output system may increase versatility and flexibility of the transmission system. For example, an output system may be chosen based on application, so as to fit a particular package or correspond to a particular vehicle type.

Turning now to FIG. 6, a table 600 is shown illustrating operational gears and clutch engagement thereof for a transmission system as herein disclosed, for example the transmission system 200, the transmission system 400, and/or the transmission system 500. The operational gears may include the first gear ratio and the second gear ratio, as previously described.

In the first gear ratio, the first dog clutch selector may be in the first position, the second dog clutch selector may be in the first position, and the third dog clutch selector may be in the first position. As previously described, in the first position, a respective first clutch gear may be engaged with a respective intermediate shaft, as an example the first clutch gear 236 of the first dog clutch selector 234 may be engaged with the first intermediate shaft 228.

In the second gear ratio, the first dog clutch selector may be in the second position, the second dog clutch selector may be in the second position, and the third dog clutch selector may be in the second position. As previously described, in the second position, a respective second clutch gear may be engaged with a respective intermediate shaft, as an example the second clutch gear 238 of the first dog clutch selector 234 may be engaged with the first intermediate shaft 228.

While not shown in the table 600, multiple overlapping gear ratios may be possible. For example, an overlapping gear ratio wherein the first dog clutch selector is in the second position, the second dog clutch selector is in the first position, and the third dog clutch selector is in the first position may be possible. Another overlapping gear ratio wherein the first dog clutch selector is in the second position, the second dog clutch selector is in the second position, and the third dog clutch selector is in the first position may be possible. Various other overlapping gear ratios are also possible. Overlapping gear ratios may allow for more quickly powershifting to fully in first or second gear ratio.

FIG. 7 illustrates a timing diagram 700 of a use-case control strategy for a transmission system, such as any of the previously described transmission systems or combinations of the transmission systems. The timing diagram 700 may represent a powershifting scenario from a first gear ratio to a second gear ratio. In each graph, time is indicated on the abscissa and increases from left to right. The ordinates for plots 702, 704, and 706 indicate positions of the first, second, and third dog clutch selectors, respectively, (e.g., first position, second position, and neutral). The ordinates for plots 708, 710, and 712 indicate torques of the first, second, and third electric motors, respectively. Torques as herein described may be 0%, 100%, and 150%, where 100% represents a torque output prior to a shift (e.g., a pre-shift torque) and 150% represents a torque output that is 150% of the pre-shift torque. In some examples, torque may be greater than 0% but less than 100%. The ordinates for plots 714, 716, and 718 indicate speeds of the first, second, and third electric motors, respectively (e.g., first gear ratio speed and second gear ratio speed). As herein described, the first motor and the first dog clutch selector may be part of a first motor-transmission subassembly, the second motor and the second dog clutch selector may be part of a second motor-transmission subassembly, and the third motor and the third dog clutch selector may be part of a third motor-transmission subassembly.

At time t0, the transmission system is in the first gear ratio with each of the first, second, and third dog clutch selectors being in the first position and each of the first, second, and third electric motors have a torque output of 100% at first gear ratio speed. Between t0 and t1, torque of the first electric motor that is undergoing a shift reduces to 0% and the torques of the second and third electric motors increases to 150%. At t1, the position of the first dog clutch selector shifts from first position to neutral. Between t1 and t2, torque of the first electric motor may temporarily increase above 0% by a predefined amount to allow the speed of the first motor to decrease from the first gear ratio speed to the second gear ratio speed. As such, the torque may be zero for engagement and/or disengagement but may be non-zero when the motor is accelerating/decelerating or synchronizing to a speed in order to continuously compensate its own inertia. At t2, the position of the first dog clutch selector shifts from neutral to second position. Between t2 and t3, the torque of the first electric motor may increase from 0% to 100% and the torques of the second and third electric motors may decrease from 150% to 100%. At time t3, the transmission system may be in an overlapping gear ratio with the first motor-transmission subassembly in the second gear ratio and the second and third motor-transmission subassemblies in the first gear ratio.

Between t3 and t4, torque of the second electric motor reduces to 0% and torques of the first and third electric motors increase to 150%. At t4, position of the second dog clutch selector shifts from first position to neutral. Between t4 and t5, torque of the second electric motor may temporarily increase above 0% by a predefined amount to allow the speed of the second electric motor to decrease from the first gear ratio speed to the second gear ratio speed. As such, the torque may be zero for engagement and/or disengagement but may be non-zero when the motor is accelerating/decelerating or synchronizing to a speed in order to continuously compensate its own inertia. At t5, the position of the second dog clutch selector shifts from neutral to second position. Between t5 and t6, torque of the second electric motor increases to 100% and torques of the first and third electric motors decreases to 100%. At time t6, the transmission system may be in an overlapping gear ratio with the first and second motor-transmission subassemblies in the second gear ratio and the third motor-transmission subassembly in the first gear ratio.

Between times t6 and t7, torque of the third electric motor reduces to 0% and torques of the first and second electric motors increase to 150%. At time t7, position of the third dog clutch selector shifts from first position to neutral. Between times t7 and t8, torque of the third electric motor may temporarily increase above 0% by a predefined amount to allow speed of the third electric motor may to decrease from the first gear ratio speed to the second gear ratio speed. As such, the torque may be zero for engagement and/or disengagement but may be non-zero when the motor is accelerating/decelerating or synchronizing to a speed in order to continuously compensate its own inertia. At time t8, the position of the third dog clutch selector shifts from neutral to the second position. Between times 18 and t9, torque of the third electric motor increases to 100% and torques of the first and second electric motors decrease to 100%. At time t9, the transmission system may be fully in the second gear ratio, with each of the first, second, and third motor-transmission subassemblies in the second gear ratio.

The powershifting strategy herein described in the timing diagram 700 allows the transmission system to maintain a substantially stable output torque while sequentially shifting each motor-transmission subassembly from one gear to another. At any time, the combined output torque of the transmission system may be 300%, whether from each motor outputting 100% torque or from two of the three motors outputting 150% torque. Thus, the powershifting strategy with the three motor system that includes dog clutches as herein disclosed may increase shift quality.

In some examples, the pre-shifting torque of one or more of the electric motors may be a maximum continuous torque of the motor. The 150% torque of the one or more electric motors in such examples may correspond to a peaking torque. The peaking torque may be maintained for a short period of time, however the period of time allowable for the peaking torque may be longer than a duration of the shift. Further, while a use-case scenario for powershifting is presented for shifting from the first gear ratio to the second gear ratio, a similar powershifting strategy of maintaining a substantially stable output torque of the system while sequentially downshifting subassemblies from the second gear ratio to the first gear ratio (including transitioning from second gear ratio speed to first gear ratio speed) may be employed.

It should be understood that the first, second, and third subassemblies (e.g., first, second, and third electric motors and the first, second, and third dog clutch selectors) may not always respectively indicate the first, second, and third motor-transmission subassemblies 290, 292, and 294 (e.g., first electric motor 202, the second electric motor 204, and the third electric motor 206 or the first dog clutch selector 234, the second dog clutch selector 240, and the third dog clutch selector 246). Rather, the terms first, second, and third are herein meant to differentiate elements from one another. In some examples, the first motor-transmission subassembly 290 may be shifted first, the second motor-transmission subassembly 292 may be shifted second, and the third motor-transmission subassembly 294 may be shifted third, however in other examples, the subassemblies may be shifted in various other orders.

Further, it should be understood that the use-case control strategy as presented in the timing diagram of FIG. 7 is a non-limiting example of a powershifting scenario. In other examples, different output torques and shift strategies may be used. For example, electric motors of two of the subassemblies may have torques reduced to zero while a third motor has torque increased to 300% and clutches of the two of the subassemblies may shift from one position to another position as herein described at the same time. Additionally, it may be possible for one or two subassemblies to be shifted into the second gear ratio while a third subassembly remains in the first gear ratio and the transmission may operate with overlapping torques and speeds. This may allow for quickly shifting to fully in the first gear ratio or fully in the second gear ratio depending on user intent.

Referring now to FIG. 8, a method 800 for operation of a transmission system is shown. The method 800 may be carried out by any of the transmission systems or combinations of the transmission systems described above with respect to FIGS. 2-5. However, the method 800 may be carried out via other suitable transmissions, in other examples. Furthermore, the method 800 may be implemented by a controller that includes a processor and memory, as previously described.

At 802, method 800 includes determining operating conditions. The operating conditions may include input device positions (e.g., gearshift lever position), clutch configuration(s), output speed, motor speeds, motor torques, total output torque, vehicle speed, vehicle load, ambient temperature, and the like. The operating conditions may be ascertained via sensor inputs, modeling, look-up tables, and other suitable techniques.

At 804, method 800 includes judging if a powershift in the transmission should be implemented for selective shifting of one or more dog clutches of respective motor-transmission subassemblies of the transmission system. Such a determination may be carried out responsive to vehicle speed surpassing a threshold value, actual output torque, and/or accelerator pedal position, in some examples. In other examples, operator interaction with a gear selector and/or clutch actuator may initiate powershift operation.

If it is determined that a powershift should not occur (NO at 804), the method proceeds to 812 where the method 800 includes maintaining the current transmission operating conditions of the transmission system. For instance, the transmission system may be maintained in the first gear ratio.

Conversely, if it is determined that a powershift should occur (YES at 804), the method moves to 806 where the method 800 includes shifting the gear of a first motor-transmission subassembly. As is described with respect to FIG. 2, the transmission system may include a plurality of motor-transmission subassemblies, each including an electric motor and a dog clutch selector with three positions including a first position corresponding to the first gear ratio, neutral, and a second position corresponding to the second gear ratio.

At 806, the dog clutch selector of the first motor-transmission subassembly may be shifted from one gear to another (e.g., from the first gear ratio to the second gear ratio or vice versa) and the electric motor may transition from one speed to another speed (e.g., first gear ratio speed to second gear ratio speed or vice versa), as is outlined in the timing diagram 700 of FIG. 7.

At 808, method 800 optionally includes shifting the gear of a second motor-transmission subassembly. Similar to as described for the first motor-transmission subassembly, a dog clutch selector of the second transmission subassembly may be shifted from one gear to another and speed of an electric motor of the second motor-transmission subassembly may transition from one speed to another speed.

At 810, method 800 optionally includes shifting the gear of a third motor-transmission subassembly. Similar to as described for the first and second motor-transmission subassemblies, a dog clutch selector of the third transmission subassembly may be shifted from one gear to another and speed of an electric motor of the third motor-transmission subassembly may transition from one speed to another. If all three of the motor-transmission subassemblies are shifted from one gear to another, the transmission system may be fully in the other gear (e.g., fully in the second gear ratio). If powershifting is halted after shifting of the first or the second motor-transmission subassemblies, such that one or more of the motor transmission subassemblies is in a different gear than the other motor transmission subassembly(s), the transmission system may be in an overlapping gear ratio. When in an overlapping gear ratio, the method 800 may optionally return to 802 to determine operating conditions and then powershift again, if to be implemented. Powershifting again may include shifting one or more of the plurality of motor-transmission subassemblies, in some examples to shift from an overlapping gear ratio to fully in the first or the second gear ratio.

A technical effect of the systems and methods herein presented is that high power output may be achieved using a plurality of lower power electric motors while maintaining powershifting ability. Lower power electric motors may be more readily available for manufacture, and therefore the efficiency of manufacturing the transmission system may be increased while allowing the system to be used for applications that demand high power output. Efficiency of the transmission system herein disclosed may be increased with inclusion of dog clutches.

Further, the powershifting strategy herein described may allow for sustained total torque output during powershifting as well as allowing overlapping gear ratios to be used when output speed range for the first gear ratio overlaps with the output speed range for the second gear ratio. Overlapping gear ratios may allow the transmission to more quickly shift fully into the first or second gear ratios.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines. The subject matter of the present disclosure includes all novel and non-obvious combinations and sub-combinations of the various systems and configurations, and other features, functions, and/or properties disclosed herein.

The disclosure also provides support for an electric drive unit for an electric vehicle, comprising: a transmission system comprising: a plurality of motor-transmission subassemblies, wherein each subassembly comprises: an electric motor rotationally coupled to an input shaft, wherein the input shaft comprises a first gear and a second gear, and an intermediate shaft comprising a dog clutch selector, a first clutch gear, and a second clutch gear, wherein the first clutch gear is meshed with the first gear of the input shaft and the second clutch gear is meshed with the second gear of the input shaft and wherein the dog clutch selector is configured to selectively couple the first or second clutch gear to the intermediate shaft, an output system comprising an output shaft coupled to one or more output interfaces and rotationally coupled to the plurality of motor-transmission subassemblies, and a controller configured to, in response to a request to powershift, increase torque of at least one electric motor while at least one other motor-transmission subassembly is undergoing a shift, where a torque of the at least one other motor-transmission subassembly is reduced to zero. In a first example of the system, the plurality of motor-transmission subassemblies comprises a first motor-transmission subassembly, a second motor-transmission subassembly, and a third motor-transmission subassembly. In a second example of the system, optionally including the first example, the first motor-transmission subassembly comprises a first intermediate shaft, the second motor-transmission subassembly comprises a second intermediate shaft, and the third motor-transmission subassembly comprises a third intermediate shaft. In a third example of the system, optionally including one or both of the first and second examples, each of the first, second, and third intermediate shafts are rotationally coupled to the output shaft of the output system. In a fourth example of the system, optionally including one or more or each of the first through third examples, each of the first, second, and third intermediate shafts include a gear that meshes with an output shaft gear rotationally coupled to the output shaft. In a fifth example of the system, optionally including one or more or each of the first through fourth examples, each of the first, second, and third intermediate shafts are rotationally coupled to a layshaft and the layshaft is rotationally coupled to the output shaft. In a sixth example of the system, optionally including one or more or each of the first through fifth examples, the controller is configured to maintain a total output torque while powershifting one or more of the plurality of motor-transmission subassemblies. In a seventh example of the system, optionally including one or more or each of the first through sixth examples, the controller is configured to powershift a first motor-transmission subassembly from a first gear ratio to a second gear ratio while maintaining a second and a third motor-transmission subassembly in the first gear ratio, powershift the second motor-transmission subassembly from the first gear ratio to the second gear ratio while maintaining the first motor-transmission subassembly in the second gear ratio and the third motor-transmission subassembly in the first gear ratio, and powershift the third motor-transmission subassembly from the first gear ratio to the second gear ratio while maintaining the first and second motor-transmission subassemblies in the second gear ratio. In a eighth example of the system, optionally including one or more or each of the first through seventh examples, the controller is configured to powershift the transmission system from fully in a first gear ratio to in an overlapping gear ratio by shifting one or more of the plurality of motor-transmission subassemblies from the first gear ratio to a second gear ratio and maintaining the other one or more of the plurality of motor-transmission subassemblies in the first gear ratio. In a ninth example of the system, optionally including one or more or each of the first through eighth examples, the controller is configured to powershift a first motor-transmission subassembly from a first gear ratio to a second gear ratio, wherein powershifting the first motor-transmission subassembly from the first gear ratio to the second gear ratio comprises: decreasing torque of the first motor-transmission subassembly to zero, increasing torques of a second and a third motor-transmission subassembly to 150% of respective pre-shift torques, shift the first motor-transmission subassembly to the second gear ratio, increase torque of the first motor-transmission subassembly to a respective pre-shift torque and decrease the torques of the second and the third motor-transmission subassembly to respective pre-shift torques.

The disclosure also provides support for a method for operation of a transmission system in an electric drive unit, comprising: transitioning between a first gear ratio and a second gear ratio via selective engagement and disengagement of one or more clutch gears of one or more dog clutch selectors of the transmission system, wherein the transmission system includes: a first motor-transmission subassembly, a second motor-transmission subassembly, and a third motor-transmission subassembly, wherein each of the first, second, and third motor-transmission subassemblies comprises an electric motor rotationally coupled to an input shaft that comprises a first gear and a second gear and an intermediate shaft comprising a dog clutch selector with a first clutch gear and a second clutch gear, wherein the first gear meshes with the first clutch gear and the second gear meshes with the second clutch gear, and an output shaft rotationally coupled to each of the first, second, and third motor-transmission subassemblies, and transferring mechanical power from the first, second, and third motor-transmission subassemblies to the output shaft. In a first example of the method, each dog clutch selector comprises: a first position wherein the first clutch gear is engaged with the intermediate shaft and the second clutch gear is disengaged from the intermediate shaft, a second position wherein the second clutch gear is engaged with the intermediate shaft and the first clutch gear is disengaged from the intermediate shaft, and a neutral position wherein both the first and second clutch gears are disengaged from the intermediate shaft. In a second example of the method, optionally including the first example, transitioning between the first gear and the second gear comprises shifting a first dog clutch selector of the first motor-transmission subassembly from first position to second position, shifting a second dog clutch selector of the second motor-transmission subassembly from first position to second position, and shifting a third dog clutch selector of the third motor-transmission subassembly from first position to second position. In a third example of the method, optionally including one or both of the first and second examples for a given dog clutch selector, transitioning between the first gear and the second gear comprises reducing a torque of a corresponding electric motor to zero while increasing torque of one or more other electric motors, shifting the dog clutch selector into the neutral position, changing speed of the corresponding electric motor from a first gear ratio speed to a second gear ratio speed, shifting the dog clutch selector into the second position, and increasing the torque of the corresponding electric motor to a pre-shift torque while decreasing torques of the one or more other electric motors to respective pre-shift torques.

The disclosure also provides support for a transmission system, comprising: three motor-transmission subassemblies, and an output system rotationally coupled to each motor-transmission subassembly, wherein each motor-transmission subassembly comprises: a motor rotationally coupled to an input shaft that is further rotationally coupled to a first gear and a second gear, an intermediate shaft selectively rotationally coupled to the input shaft via selective engagement of dog clutch that comprises a first clutch gear meshed with the first gear and a second clutch gear meshed with the second gear. In a first example of the system, engagement of a respective first clutch gear with a corresponding intermediate shaft for each of the three motor-transmission subassemblies corresponds to a first gear ratio of the transmission system and engagement of a respective second clutch gear with the corresponding intermediate shaft for each of the three motor-transmission subassemblies corresponds to a second gear ratio of the transmission system. In a second example of the system, optionally including the first example, engagement of a respective first clutch gear with a corresponding intermediate shaft for each of one or more first motor-transmission subassemblies and engagement of a respective second clutch gear with another corresponding intermediate shaft for each of one or more second motor-transmission subassemblies corresponds to an overlapping gear ratio. In a third example of the system, optionally including one or both of the first and second examples, the output system comprises an output shaft rotationally coupled to the intermediate shaft of each motor-transmission subassembly via a gear meshing. In a fourth example of the system, optionally including one or more or each of the first through third examples, the output system comprises a layshaft rotationally coupled to the intermediate shaft of each motor-transmission subassembly via first gear meshings and to an output shaft via a second gear meshing. In a fifth example of the system, optionally including one or more or each of the first through fourth examples, the output system couples to one or more output interfaces.

Note that the example control and estimation routines included herein can be used with various powertrain, electric drive, and/or vehicle system configurations. The control methods and routines disclosed herein may be stored as executable instructions in non-transitory memory and may be carried out by the control system including the controller in combination with the various sensors, actuators, and other transmission and/or vehicle hardware in combination with the electronic controller. As such, the described actions, operations, and/or functions may graphically represent code to be programmed into non-transitory memory of the computer readable storage medium in the electric transmission system and/or vehicle system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

As used herein, the term “approximately” is construed to mean plus or minus five percent of the range, unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric drive unit for an electric vehicle, comprising:
a transmission system comprising:
a plurality of motor-transmission subassemblies, wherein each subassembly comprises:
an electric motor rotationally coupled to an input shaft, wherein the input shaft comprises a first gear and a second gear; and
an intermediate shaft comprising a dog clutch selector, a first clutch gear, and a second clutch gear, wherein the first clutch gear is meshed with the first gear of the input shaft and the second clutch gear is meshed with the second gear of the input shaft and wherein the dog clutch selector is configured to selectively couple the first or second clutch gear to the intermediate shaft;
an output system comprising an output shaft coupled to one or more output interfaces and rotationally coupled to the plurality of motor-transmission subassemblies; and
a controller configured to, in response to a request to powershift, increase torque of at least one electric motor while at least one other motor-transmission subassembly is undergoing a shift, where a torque of the at least one other motor-transmission subassembly is reduced to zero.

2. The electric drive unit of claim 1, wherein the plurality of motor-transmission subassemblies comprises a first motor-transmission subassembly, a second motor-transmission subassembly, and a third motor-transmission subassembly.

3. The electric drive unit of claim 2, wherein the first motor-transmission subassembly comprises a first intermediate shaft, the second motor-transmission subassembly comprises a second intermediate shaft, and the third motor-transmission subassembly comprises a third intermediate shaft.

4. The electric drive unit of claim 3, wherein each of the first, second, and third intermediate shafts are rotationally coupled to the output shaft of the output system.

5. The electric drive unit of claim 3, wherein each of the first, second, and third intermediate shafts include a gear that meshes with an output shaft gear rotationally coupled to the output shaft.

6. The electric drive unit of claim 3, wherein each of the first, second, and third intermediate shafts are rotationally coupled to a layshaft and the layshaft is rotationally coupled to the output shaft.

7. The electric drive unit of claim 1, wherein the controller is configured to maintain a total output torque while powershifting one or more of the plurality of motor-transmission subassemblies.

8. The electric drive unit of claim 1, wherein the controller is configured to powershift a first motor-transmission subassembly from a first gear ratio to a second gear ratio while maintaining a second and a third motor-transmission subassembly in the first gear ratio; powershift the second motor-transmission subassembly from the first gear ratio to the second gear ratio while maintaining the first motor-transmission subassembly in the second gear ratio and the third motor-transmission subassembly in the first gear ratio; and powershift the third motor-transmission subassembly from the first gear ratio to the second gear ratio while maintaining the first and second motor-transmission subassemblies in the second gear ratio.

9. The electric drive unit of claim 1, wherein the controller is configured to powershift the transmission system from fully in a first gear ratio to in an overlapping gear ratio by shifting one or more of the plurality of motor-transmission subassemblies from the first gear ratio to a second gear ratio and maintaining the other one or more of the plurality of motor-transmission subassemblies in the first gear ratio.

10. The electric drive unit of claim 1, wherein the controller is configured to powershift a first motor-transmission subassembly from a first gear ratio to a second gear ratio, wherein powershifting the first motor-transmission subassembly from the first gear ratio to the second gear ratio comprises:
decreasing torque of the first motor-transmission subassembly to zero;
increasing torques of a second and a third motor-transmission subassembly to 150% of respective pre-shift torques;
shift the first motor-transmission subassembly to the second gear ratio;
increase torque of the first motor-transmission subassembly to a respective pre-shift torque and decrease the torques of the second and the third motor-transmission subassembly to respective pre-shift torques.

11. A method for operation of a transmission system in an electric drive unit, comprising:
transitioning between a first gear ratio and a second gear ratio via selective engagement and disengagement of one or more clutch gears of one or more dog clutch selectors of the transmission system;
wherein the transmission system includes:
a first motor-transmission subassembly, a second motor-transmission subassembly, and a third motor-transmission subassembly, wherein each of the first, second, and third motor-transmission subassemblies comprises an electric motor rotationally coupled to an input shaft that comprises a first gear and a second gear and an intermediate shaft comprising a dog clutch selector with a first clutch gear and a second clutch gear, wherein the first gear meshes with the first clutch gear and the second gear meshes with the second clutch gear; and
an output shaft rotationally coupled to each of the first, second, and third motor-transmission subassemblies; and
transferring mechanical power from the first, second, and third motor-transmission subassemblies to the output shaft.

12. The method of claim 11, wherein each dog clutch selector comprises:
a first position wherein the first clutch gear is engaged with the intermediate shaft and the second clutch gear is disengaged from the intermediate shaft;
a second position wherein the second clutch gear is engaged with the intermediate shaft and the first clutch gear is disengaged from the intermediate shaft; and
a neutral position wherein both the first and second clutch gears are disengaged from the intermediate shaft.

13. The method of claim 12, wherein transitioning between the first gear and the second gear comprises shifting a first dog clutch selector of the first motor-transmission subassembly from first position to second position, shifting a second dog clutch selector of the second motor-transmission subassembly from first position to second position, and shifting a third dog clutch selector of the third motor-transmission subassembly from first position to second position.

14. The method of claim 12, wherein, for a given dog clutch selector, transitioning between the first gear and the second gear comprises reducing a torque of a corresponding electric motor to zero while increasing torque of one or more other electric motors, shifting the dog clutch selector into the neutral position, changing speed of the corresponding electric motor from a first gear ratio speed to a second gear ratio speed, shifting the dog clutch selector into the second position, and increasing the torque of the corresponding electric motor to a pre-shift torque while decreasing torques of the one or more other electric motors to respective pre-shift torques.

15. A transmission system, comprising:
three motor-transmission subassemblies; and
an output system rotationally coupled to each motor-transmission subassembly, wherein each motor-transmission subassembly comprises:
a motor rotationally coupled to an input shaft that is further rotationally coupled to a first gear and a second gear;
an intermediate shaft selectively rotationally coupled to the input shaft via selective engagement of dog clutch that comprises a first clutch gear meshed with the first gear and a second clutch gear meshed with the second gear.

16. The transmission system of claim 15, wherein engagement of a respective first clutch gear with a corresponding intermediate shaft for each of the three motor-transmission subassemblies corresponds to a first gear ratio of the transmission system and engagement of a respective second clutch gear with the corresponding intermediate shaft for each of the three motor-transmission subassemblies corresponds to a second gear ratio of the transmission system.

17. The transmission system of claim 15, wherein engagement of a respective first clutch gear with a corresponding intermediate shaft for each of one or more first motor-transmission subassemblies and engagement of a respective second clutch gear with another corresponding intermediate shaft for each of one or more second motor-transmission subassemblies corresponds to an overlapping gear ratio.

18. The transmission system of claim 15, wherein the output system comprises an output shaft rotationally coupled to the intermediate shaft of each motor-transmission subassembly via a gear meshing.

19. The transmission system of claim 15, wherein the output system comprises a layshaft rotationally coupled to the intermediate shaft of each motor-transmission subassembly via first gear meshings and to an output shaft via a second gear meshing.

20. The transmission system of claim 15, wherein the output system couples to one or more output interfaces.
